(19) United States
(12) Patent Application Publication
(10) Pub. No.: US 2002/0162101 A1
(43) Pub. Date: Oct. 31, 2002

(54) Method of and apparatus for enabling recommendations to be made to users of entertainment receivers

(75) Inventors: Srinivas Gutta, Buchanan, NY (US); Lalitha Agnihotri, Fishkill, NY (US); Mi-Suen Lee, Ossining, NY (US); Santhana Krishnamachari, Ossining, NY (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/842,625

(22) Filed: Apr. 27, 2001

(51) Int. Cl. H04N 7/16; H04H 9/00

(52) U.S. Cl. 725/9

(57) ABSTRACT

Entertainment recommendations are made to a user of receivers responsive to broadcast signals. The receivers include an automotive vehicle radio receiver, a residential television receiver, a residential radio receiver, a residential or automotive CD player, and a receiver of Internet content, that is, a personal computer having a modem connection to the Internet. A storage device associated with at least two of the receivers stores compiled information about the user's program type preferences for the associated receivers. A signal combiner associated with at least one of the receivers combines the user's program type preferences for the receivers. A display coupled with the signal combiner makes the recommendations in response to the combined user's program type preferences for the receivers.

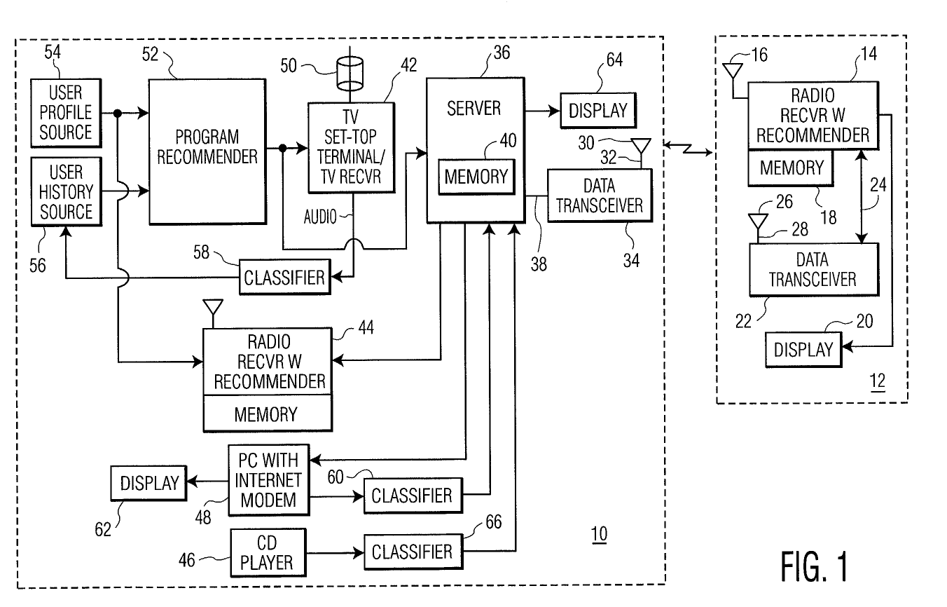

### FIELD OF INVENTION

The present invention relates generally to methods of and apparatus for enabling recommendations to be made to users of receivers responsive to broadcast signals and, more particularly, to a method of and apparatus wherein program type preferences for a plurality of such receivers are combined to provide the recommendations.

### BACKGROUND ART

A typical entertainment receiver such as a portable, automotive or home radio receiver or a television receiver includes a tuner for passing a carrier frequency of a program source and program information modulated on the carrier frequency to circuitry for driving an output device including one or more speakers. In many receivers, a user presets the carrier frequencies a tuner passes by activating buttons on a console or a remote control unit. The user accesses program sources by pressing one or more of the buttons. In many radio receivers, a frequency band is scanned for available stations, that is, stations having received signal strengths in excess of a threshold. The program type of the available stations is typically presented in order of increasing or decreasing frequency. Such scanning is usually performed by activating two buttons on the receiver console.

We are aware that more sophisticated systems have been developed to assist users of entertainment receivers in deciding what program they want to hear and review. One such system is referred to as the radio data system (RDS), which involves frequency modulation (FM) radio transmitters and receivers. In the RDS system, digital data indicative of program type are transmitted on a subcarrier of a program source. An FM receiver with RDS capability responds to the subcarrier to activate a display to provide a user of the receiver with a visual indication of the program content type. A receiver responsive to the RDS transmitter includes push buttons enabling the user to insert into the receiver the type of programming he/she desires to hear. The receiver responds to the listener's input and compares the program type codes the receiver receives from the various RDS transmitters and matches one of the received programs with the desired program type. RDS has the disadvantages of requiring special RDS transmitters and incompatibility with amplitude modulated (AM) program sources.

A number of devices have also been proposed or suggested for recommending television programming. In the TIVO system, commercially available from TIVO, Inc., of Sunnyvale, California, viewers rate shows using a “Thumbs Up and Thumbs Down” feature to indicate programs that the viewer likes and dislikes, respectively. Thereafter, the TIVO receiver matches the recorded viewer preferences with received program data in the form of an electronic program guide to make recommendations tailored to each viewer.

Such television programming recommending devices provide the viewer with program selections the viewer is expected to prefer based on the viewer's past viewing history as well as a profile containing viewer preferences. The profile is obtained in response to explicit profile information the user is supposed to supply to the device at the time of set up. It has been found that users frequently do not take the time required to sufficiently detail their viewing preferences to obtain an accurate user profile.

The co-pending, commonly assigned application Ser. No. 09/466406, filed Dec. 17, 1999, by Gutta et al, entitled Method and Apparatus for Recommending Television Programming Using Decision Trees, discloses a method of and apparatus for recommending television programs to a television viewer in response to stored signals indicative of a user profile and viewer viewing history. The co-pending, commonly assigned application filed Mar. 30, 2001, by Gutta et al, entitled “Entertainment Receiver Activated in Response to Received Program Content And Method of Operating Same,” Philips Docket US 010108, discloses an entertainment receiver, particularly a radio receiver, activated in response to received program type. In the latter application, the receiver compiles and stores signals based on a user's preferred program type, which is derived by monitoring and analyzing the user's listening pattern. (The disclosures of the previously mentioned co-pending applications are incorporated herein by reference.) It is desirable to obtain as much information as possible to compile the profile for recommending programs to users of sophisticated television and radio receivers having the ability to provide users with indications of preferred or recommended program type and/or the ability to automatically select preferred program type.

### SUMMARY OF THE INVENTION

In accordance with the present invention, entertainment recommendations are made to a user of receivers responsive to broadcast signals by compiling information about the user's program type preferences for at least two of the receivers. The user's program type preferences for the receivers are combined to provide the entertainment recommendations.

Preferably, one of the receivers is a television receiver and another of the receivers is a radio receiver. However, the invention is not limited to television and radio receivers and information about the user's program type preferences can be obtained by monitoring the user's listening habits of recorded music and by responding to Internet sites the user frequents.

The combining operation can be performed in the receiver, particularly if the receiver is an automotive vehicle radio receiver. In addition, or alternatively, the combining operation can be performed at a computer server in a residence where the television receiver, and/or a computer interfaced with the Internet, and/or a music playback unit is located. Such a computer server functions as a central station responsive to program preferences derived in response to some or all of the program receivers. In the context of the present document, a computer communicating with an Internet site and a playback device of recorded music, such as a tape or CD player, is considered to be a receiver responsive to broadcast signals.

Preferably, the user's combined program type preferences are communicated to at least one of the receivers. The recommendations are made by displaying the user's combined program type preferences or by automatically controlling received program type of at least one of the receivers in response to the user's combined program type preferences. In the former case, the user usually responds to the displayed program type preferences, e.g., by manually activating a pushbutton or keys on a keyboard.

The user's program type preferences can include actual program type, a feature that is particularly desirable for use with automotive vehicle radio receivers. In such a situation, the vehicle includes a storage device for storing the program type communicated to the vehicle from the server. The stored program type is played through the receiver in the vehicle to the user in response to the user performing an activating step, such as turning on the radio in the vehicle.

The above and still further objects, features and advantages of the present invention will become apparent upon consideration of the following detailed description of a specific embodiment thereof, especially when taken in conjunction with the accompanying drawing.

### BRIEF DESCRIPTION OF THE DRAWINGS

The single FIGURE is a block diagram of a preferred embodiment of the invention.

### DETAILED DESCRIPTION OF THE DRAWING

Reference is now made to the sole FIGURE of the drawing which includes residential site 10 and automotive vehicle 12 including radio receiver 14 of the type described in the previously mentioned co-pending application filed Mar. 30, 2001. Radio receiver 14 is of the AM or FM type and responds to broadcast signals coupled to it by antenna 16. The broadcast signals are of the conventional type and do not require RDS coding.

As described in the application filed Mar. 30, 2001, receiver 14 includes memory system 18 and display 20 for respectively storing and indicating program type preferences for the vehicle user. Memory system 18 can include a random access memory (RAM), a read-only memory (ROM), a hard disk, a slot for a CD-ROM and a slot for a floppy disk.

Vehicle 12 also includes data transceiver 22 having a low power transmitter section. Transceiver 22 is coupled with memory system 18 of receiver 14 by line 24 and to antenna 26 by line 28. Receiver 14 includes a microprocessor (not shown) which responds to signals that memory system 18 stores to read signals indicative of the program type preferences for the user of vehicle 12 from memory system 18 to data transceiver 22. Vehicle 12 can also include a tape or CD player music playback device (not shown) which drives a program type classifier in receiver 14, the contents of which are read to memory system 18, virtually on a real time basis. The microprocessor in receiver 14 reads the signals indicative of the program type preferences to data transceiver 22, either periodically, for example, late at night when vehicle 12 is usually adjacent residential site 10; or from time to time, for example, immediately after the operator of vehicle 12 removes the key from the vehicle key slot at which time the vehicle is likely adjacent site 10.

Data transceiver 22 drives antenna 26 with the signals indicative of the program type preferences that memory system 18 stores, which signals antenna 26 couples to antenna 30 at residential site 10. Line 32, connected between antenna 30 and data transceiver 34 at site 10, drives transceiver 34 with signals indicative of the program type preferences memory system 18 stores. Transceiver 34 has a low power transmitter section for coupling signals to transceiver 22 by a communications link established between antennae 26 and 30. The low power transmitter sections of transceivers 22 and 34 are such that a communication link is established between site 10 and vehicle 12 only when the vehicle is in close proximity to site 10; for example, when the vehicle is in a garage, driveway, or on the street next to site 10. Antennae 26 and 30 emit low powers that comply with the regulations of the Federal Communications Commission or other applicable regulatory bodies.

Site 10 includes computer server 36, connected by line 38 to data transceiver 34. Line 38 supplies server 36 with signals indicative of the program type preferences memory system 18 stores for the user of receiver 14 and the playback unit in vehicle 12. Line 38 also supplies data transceiver 34 with signals indicative of program type preferences that memory system 40 of server 36 stores for users of program sources at site 10; memory system 40 is of the typical type included in a server and thus includes all the storage devices previously mentioned in connection with memory system 18. Data transceiver 34, from time to time or periodically, transmits to data transceiver 22 the signals indicative of program type preferences that memory 40 stores. Transceiver 22 relays these program type preference signals to memory 18 of vehicle 12. For example, a microprocessor (not shown) included in server 36 controls memory 40 to read the program type preferences that memory 40 stores for the program sources at site 10 to transceiver 34 in response to the microprocessor of server 36 sensing a substantial change in the program type preferences memory 40 stores. Alternatively, the microprocessor that server 36 includes contains a time of day clock for activating memory 40 at the same time each day, or the same time each weekday, to drive transceiver 34 with the program type preferences memory 40 stores for the program sources at site 10. In a further alternative, each time the ignition of vehicle 12 is turned on, the microprocessor in receiver 14 attempts to access memory 40 via transceivers 22 and 34, causing the user's preferences loaded in memory 40 to be loaded into memory 18 when the vehicle is adjacent site 10.

Server 36 responds to signals indicative of the user's program type preferences resulting from several different program sources, namely television receiver 42, radio receiver 44, CD player 46, and personal computer 48 having Internet access via a modem. Television receiver 42 or a set-top terminal is connected to a television antenna, a cable link, a satellite feed or any other suitable program source by coaxial cable 50. Television receiver 42 responds to signals program recommender 52 derives by displaying the recommended programs on the receiver screen. Program recommender 52, preferably constructed as described in Ser. No. 09/466,406, responds to user profile signals that user profile signal source 54 derives and signals indicative of the viewing program history of the user, as derived by user history signal source 56. Typically, the profile that source 54 derives results from a few questions the user is initially asked as a result of memory 40 driving display 58 through server 36 when program recommender 52 is initially installed.

The user history that source 56 compiles results from coupling the audio and/or video output of television receiver 42 to program content (that is, program type) classifier 58, which derives a digital signal indicative of the type of program the user is viewing. If classifier 58 responds to the audio output of receiver 42, the classifier includes a vocoder (not shown) connected to be responsive to the audio output of television receiver 42; the classifier is of any suitable type, such as disclosed by Pfeiffer et al., in an article entitled “Automatic Audio Content Analysis,” published in the Proceedings ACM Multimedia 96, Boston, Mass., Nov. 18-22, 1996. In a preferred embodiment, classifier 58 is an application-specific integrated circuit (ASIC), or the function of classifier 58 can be included in the microprocessor of server 36.

Classifier 58 derives a digital output signal indicative of the program type of the program the viewer of television receiver 42 is watching. Classifier 58 derives one of several different digital signals indicative of the genre, or music type or talk type of the program being viewed. If the program signal is a music type, classifier 58 derives a signal indicative of the type of music, for example, classical, country, rock, swing or jazz. If the program is a talk type, classifier 58 derives a signal indicative of the type of talk, for example, news, sports or drama.

Classifier 58 can recognize program type by using feature template based approaches. For example, music and music type can be recognized by responding to the fact that songs with lyrics usually start with only instrumental content, and after a few seconds the lyrics are blended with the instrumental content. Classifier 58 derives a template for the first few seconds of the song. Alternatively, classifier 58 performs a speech to text conversion on a program or sub-program level. The program usually contains several segments; for example, a news program usually contains weather, financial, traffic, local, national, international and sports segments. Classifier 58 responds to such segments at the subprogram level to derive output signals associated with the type of each segment. Source 56, essentially a storage device which can be included in memory system 40 of server 36, responds to the outputs of classifier 58 to supply signals to program recommender 52. User profile source 54 is also essentially a storage device which can be included in memory system 40.

Hence, program recommender 52 essentially compiles a list of programs the user prefers from the actual viewing habits of the user and the initial profile the user supplies to source 54. The list is ordered by preferences of each user. Program recommender 52, in addition to supplying the list to the display screen of television receiver 42, responds to a command signal from server 36 to supply memory 40 in the server with the list, either periodically or from time to time. Typically, server 36 commands program recommender 52 to supply memory 40 with signals once a day at a predetermined time, or the program recommender includes a timer responsive to the audio output of the television receiver to supply memory 40 with signals each time television receiver 42 has been used for a predetermined elapsed time.

Each of site 10 and vehicle 12 can include an identification transducer (not shown) which, for example, can be a video camera or a weighing scale in a driver's seat of vehicle 12. The microprocessors in server 36 and receiver 18 respond to the signals from the transducer and signals that memory systems 40 and 18 store to supply the memory systems with signals indicative of user identity. Alternatively, the user can activate a key, a set of keys, button or set of buttons at receiver 14 or at a keyboard associated with server 36 to provide the microprocessors at site 10 and vehicle 12 with user identification.

Radio receiver 44 at site 10 supplies memory 40 of server 36 with signals indicative of program preferences of the user of the radio receiver. To these ends, radio receiver 44 is preferably constructed as described in the previously mentioned application filed Mar. 30, 2001. Receiver 44, like receiver 14, can operate in an implicit mode, an explicit mode, or a combination of the implicit and explicit modes. In the implicit mode, receiver 44 is not connected to the user profile that source 54 derives and the receiver supplies server 36 with signals indicative of preferred program type only in response to the listening habits of the user of the receiver. In the explicit mode, receiver 44 is connected to the user profile that source 54 derives and the receiver supplies server 36 with signals indicative of preferred program type only in response to the user profile that source 54 derives. In the combined implicit and explicit modes, radio receiver 44 supplies server 36 with signals indicative of preferred program type for the user in response to the user profile that source 54 derives and in response to the listening habits of the user of the receiver. Typically, server 36 responds to the time of day clock included in the server to command once-a-day readout to the server of the preferred program type signals stored in the memory of radio receiver 44.

Personal computer 48 includes a port for supplying to classifier 60 text signals resulting from Internet activity of the user. Classifier 60 is usually constructed the same as classifier 58. The port of computer 48 also responds to text signals personal computer 48 derives for bookmarked sites the computer stores. Thus, classifier 60 derives signals indicative of the types of Internet portals the user accesses and supplies the signals to memory 40 of server 36. Typically, personal computer 48 supplies classifier 60 with the text signals resulting from Internet activity virtually on a real-time basis and the classifier 60 supplies server 36 with the digital signals indicative of the user's Internet activity virtually on a real-time basis.

Personal computer 48 drives display 62 in the usual manner. Computer 48 is connected to be responsive to an output of server 36 which provides display 62 with the user's program preferences, typically in an ordered manner. Alternatively, server 36 drives display 64, which is dedicated to the server and is not connected to be responsive to the output of computer 48. The user of personal computer 48 can use the user's program preferences displayed on display 60 or 64 to select Internet sites of interest or personal computer 48 can include a program similar to program recommender 52 to provide automatic selection of Internet sites.

Server 36 also responds to the program type of a suitable player device 46 (e.g., a CD player, type player, or an MP3 player), which drives classifier 66, constructed identically to classifiers 58 and 60. Server 36 periodically accesses classifier 66 or the classifier can include an arrangement for supplying the server with signals indicative of the type of music played back by CD player 46.

Server 36, which can be thought of as a central control station, combines the user preference signals from radio receivers 14 and 44, and program recommender 52, as well as classifiers 60 and 66. Server 36 combines the user preference signals that are generated by receivers 14 and 44, recommender 52, as well as classifiers 60 and 66 to derive a list of recommended, that is, preferred, programs to be watched on television receiver 42, listened to by users of radio receivers 14 and 44, and to be accessed by the user when he is on-line with the Internet via computer 48. The list can be used for other purposes, for example, to provide the user with an idea of magazines, books or recorded musical selections which might be of interest to the user. Server 36 supplies the list to display 62 and/or display 64 and as an input to user history source 56, as well as radio receivers 14 and 44. Server 36 can include a computer program similar or identical to computer recommender 52 to compile the list of recommended preferred programs. Alternatively, server 36 can compile the list in other ways known to those skilled in the art.

While there has been described and illustrated a specific embodiment of the invention, it will be clear that variations in the details of the embodiment specifically illustrated and described may be made without departing from the true spirit and scope of the invention as defined in the appended claims.

We claim:

1. A method of making entertainment recommendations to a user of receivers responsive to broadcast signals comprising compiling information about the user's program type preferences for at least two of the receivers, combining the user's program type preferences for said at least two of the receivers, and making the entertainment recommendations in response to the combined user's program type preferences for said at least two of the receivers.

2. The method of claim 1 wherein the combining step is performed at a first of said at least two of the receivers.

3. The method of claim 2 wherein the first of the receivers is in an automotive vehicle.

4. The method of claim 1 further including communicating the compiled information from said at least two receivers to a central station, and performing the combining step at the central station.

5. The method of claim 4 further including communicating the user's combined program type preferences to at least one of said receivers.

6. The method of claim 1 wherein the recommendations are made by displaying the combined user's program type preferences.

7. The method of claim 1 wherein the recommendations are made by controlling received program type of at least one of the receivers in response to the combined user's program type preferences.

8. The method of claim 1 wherein the recommendations are made by controlling received program type of a plurality of the receivers in response to the combined user's program type preferences.

9. The method of claim 1 wherein the receivers include at least one of television, radio and Internet receivers.

10. The method of claim 1 wherein the receivers include television, radio and Internet receivers, and compiling information about the user's program preferences by monitoring the user's listening habits of recorded music.

11. The method of claim 1 wherein the receivers include a television receiver at a residence and an automotive vehicle radio receiver, communicating the user's program preferences from the television receiver and the automotive vehicle radio receiver to a central station, combining at the central station the user's program preferences as derived from the television receiver and the automotive vehicle radio receiver, and communicating the combined user's program preferences from the central station to at least a first of said receivers.

12. The method of claim 11 further including controlling the program type of said first receiver in response to the combined user's program preferences communicated from the central station to said first receiver.

13. The method of claim 12 wherein said first receiver is in the automotive vehicle and the user's program preferences include program type, storing the program type in the automotive vehicle, and playing the stored program type through the receiver in the automotive vehicle to the user in response to the user performing an activating step in the automotive vehicle.

14. Apparatus for enabling entertainment recommendations to be made to a user of receivers responsive to broadcast signals comprising a storage device associated with each of at least two of the receivers, each of the storage devices being arranged for storing information about the user's program type preferences for the associated receiver, a signal combiner associated with at least a first of the receivers for combining the user's program type preferences for said at least two of the receivers, and an output device coupled with the signal combiner for making the entertainment recommendations in response to the combined user's program type preferences for said at least two of the receivers.

15. The apparatus of claim 14 wherein a first of the receivers is in an automotive vehicle and the signal combiner and the output device are in the automotive vehicle.

16. The apparatus of claim 15 further including a central station arranged for combining signals indicative of the user's program preferences for said at least two receivers, and a further output device arranged to be responsive to the combined signals at the central station indicative of the user's program preferences.

17. The apparatus of claim 16 wherein each of the output devices includes a display.

18. The apparatus of claim 17 wherein at least one of the output devices is arranged for controlling program type of a receiver associated with the output device.

19. The apparatus of claim 14 further including a central station including the signal combiner, the output device being arranged to be responsive to the combined signals and the central station indicative of the user's program preferences.

20. The apparatus of claim 19 wherein the output device is arranged for controlling program type of at least one of said receivers.
